(19) United States
(12) Patent Application Publication
(10) Pub. No.: US 2003/0005125 A1
(43) Pub. Date: Jan. 2, 2003

(54) System for monitoring the path availability in a communication system based upon a server farm

(75) Inventors: Jean-Marc Berthaud, Villeneuve-Loubet (FR); Jean-Claude Dispensa, St. Jeannet (FR); Eric Lebrun, Carros (FR); Jean-Bernard Schmitt, Le Rouret (FR)

Correspondence Address: IBM Corporation T81/062, PO Box 12195, Research Triangle Park, NC, 27709, US

(73) Assignee: International Business Machines Corporation, Armonk, NY

(21) Appl. No.: 10/156,338

(22) Filed: May 28, 2002

(30) Foreign Application Priority Data
May 29, 2001 (EP) 01480045.2

(51) Int. Cl. G06F 15/173

(52) U.S. Cl. 709/226

(57) ABSTRACT

A control system in a communication system comprising a server farm connected by means of Internet Service Provider routers to the Internet or the like. The server farm includes at least a customer WEB server and all server farm resources enabling any user connected to the Internet to access the customer WEB server by using the server farm resources. The server farm includes at least one Service Level Agreement (SLA) server for periodically monitoring the availability of a path to be used by the user to access the customer WEB server.

### TECHNICAL FIELD

The present invention relates to communication systems wherein WEB servers are hosted in a server farm connected to the Internet network, and relates in particular to a system for monitoring the availability of a path through the server farm between a user and any one of the WEB servers.

### BACKGROUND

Today, a server farm typically includes a scalable infrastructure and all the facilities and resources needed to enable users to easily access a number of services. Generally, such resources are located in premises owned by a data processing equipment provider such as the IBM Corporation.

Most server farms are used today to host WEB servers of one or several customers. The network architecture of such a server farm typically includes at least two main parts: a local network to which the customer WEB servers are connected, and an Internet front-end that connects this local network to the Internet. The local network comprises different kinds of components such as Internet Access routers, Bandwidth controllers, switches and Firewalls through which requests from the users connected to the Internet are routed. The server farm is connected to the Internet via multiple links supported by Internet Service Provider (ISP) routers.

When contracting with customers for hosting their WEB servers, the owner of the server often farm commits to Service Level Agreements, which means that the server farm owner agrees to provide full availability of connectivity to the customer servers as well as low delay on the connections to these servers. To achieve this goal, it is necessary for the server farm provider to continually monitor the availability of the hosted WEB servers and also to measure their response times.

### SUMMARY OF THE INVENTION

Accordingly, an object of the invention is to provide an in situ control system for periodically monitoring the availability of the server farm resources within a communication system wherein the WEB servers of a customer are hosted in a server farm.

Another object of the invention is to provide an in situ control system for periodically measuring the response time of a path between a user and WEB server hosted in a server farm.

The invention relates therefore to a control system in a communication system comprising a server farm connected by means of Internet Service Provider (ISP) routers to the Internet network or the like, wherein the server farm includes at least a customer WEB server and server farm resources enabling any user connected to the Internet network to access the customer WEB server by using the server farm resources, such a control system including at least one Service Level Agreement (SLA) server for periodically monitoring the availability of a path to be used by the user to access the WEB server.

### BRIEF DESCRIPTION OF THE DRAWINGS

The above and other objects, features and advantages of the invention will be better understood by reading the following detailed description of the invention in conjunction with the accompanying drawings wherein:

FIG. 1 is a block diagram representing a communication system based upon a server farm and the first half path between the ISP routers and the SLA router.

FIG. 2 is a a block diagram representing the same communication system as in FIG. 1 and the second half path between the SLA router and the customer WEB server.

### DETAILED DESCRIPTION OF THE INVENTION

In order to monitor the availability and performance actually experienced by a user who accesses a server within the farm, it would be ideal to use the same path taken by end users connecting from the Internet to the customer WEB server. To implement such a practice, the best placement of the Service Level Agreement (SLA) servers would be within the Internet, outside the farm. As this placement outside the farm is impractical, according to the present invention the SLA servers are located inside the farm, and monitor two half paths, one to the Internet Service Provider routers and one to the WEB servers. A correlation is then made between the results over the two half paths to simulate the real path.

In a preferred embodiment of the invention, two SLA servers are used. They run in a High Availability mode (HACMP) with a heartbeat mechanism between them for failure detection. Only one SLA server is active at a time and the second one is used for backup in case of failure of the active SLA server.

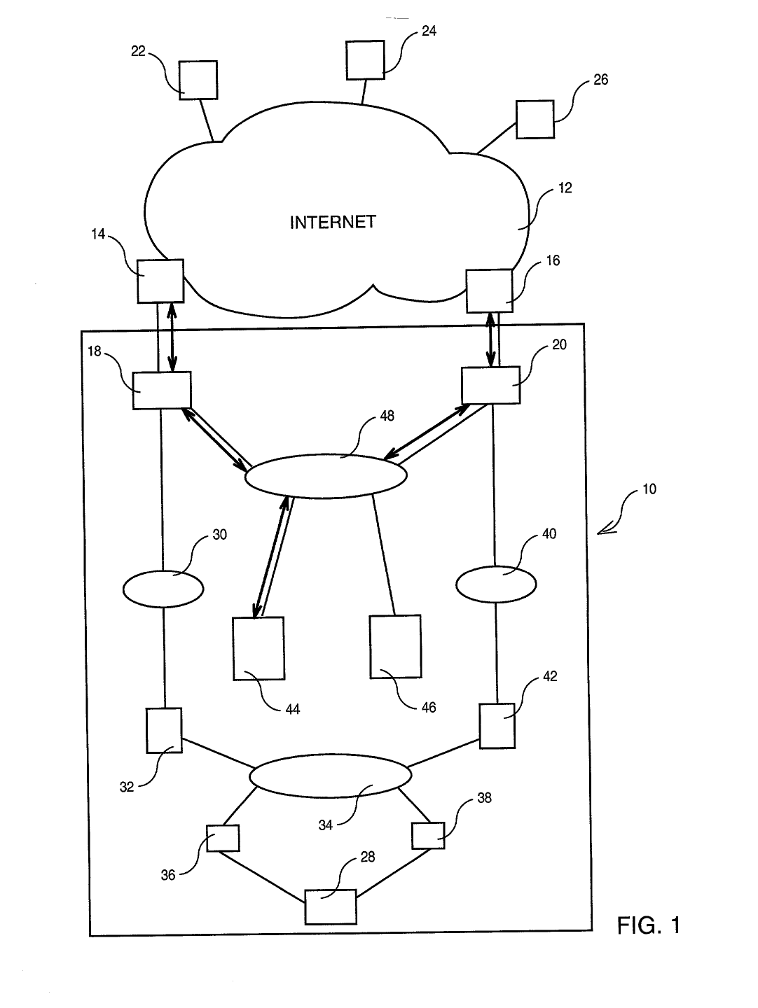

As illustrated in FIG. 1, a communication system wherein the invention is implemented includes a server farm 10 and a data transmission network 12 such as the Internet network (or another Internet Protocol (IP) network such as an Intranet network). Internet network 12 is linked to server farm 10 by means of Internet Service Provider (ISP) routers 14 and 16. The ISP routers 14 and 16 are respectively connected, inside server farm 10, to Internet Access routers 18 and 20. A plurality of users 22, 24 and 26 connected to Internet network 12 can access a customer WEB server 28 hosted in server farm 10 by using the resources of the server farm.

Within server farm 10, Internet Access router 18 may be linked to the customer WEB server 28 by means of a first switching group 30, a first bandwidth controller 32, a second switching group 34 and first and second firewalls 36 and 38. Likewise, Internet Access router 20 is linked to customer WEB server 28 by means of a third switching group 40, a second bandwidth controller 42, the second switching group 34 and the first and second firewalls 36 and 38. Each component of the server farm such a bandwidth controller or a firewall, may be duplicated as suggested by FIG. 1. Thus, at each time, one of the two components may be active (e.g. the first bandwidth controller and the first firewall) whereas the other one may be a backup component (e.g. the second bandwidth controller and the second firewall).

Note that each switching group may include a plurality of switches wherein, at each time, only a subset of them is used to determine the path that connects a user to the customer WEB server. As to the other components of the server farm, each may be is duplicated to have, at each time, an active switch and a backup switch.

The invention includes a control system that may comprise two Service Level Agreement (SLA) servers 44 and 46 which are connected respectively to Internet Access servers 18 and 20 via a fourth switching group 48. Note that, at each time, one SLA server may be active and the other kept as backup.

As illustrated by the arrows in FIG. 1, the active SLA server, e.g. SLA server 44, periodically sends a monitoring frame to both ISP routers 14 and 16. Static routes are configured in both SLA servers to reach the ISP routers with a next hop being Internet Access routers 18 and 20 respectively (via the fourth switching group 48). Note that such a frame can be sent periodically with a period of several minutes; the period may depend on the number of customer WEB servers the SLA servers monitor in the server farm.

Then, after receiving the monitoring frame from the SLA server, each ISP router answers back by forwarding an answer frame i.e., a response message to the SLA server, always by intermediary of the Internet Access router.

The above monitoring enables verification that the first half path between the server farm and the Internet network is up and running, and also enables measurement of the time necessary for a frame to be communicated between them. Such monitoring can be based upon a “ping” mechanism wherein an Internet Control Message protocol (ICMP) echo request message is sent to a specified destination. Any machine (such as a router) that receives an echo request formulates an echo reply response message and returns it to the original sender. The request contains an optional data area and the reply may contain a copy of the data sent in the request. The echo request ping and the associated reply message can be used to test whether a destination is reachable and responding. Because both the request and reply travel in IP datagrams, successful receipt of a reply verifies that major pieces of the transport system work. Thus, immediate gateways between the source and destination may be presumed to be operating correctly, and the destination machine running.

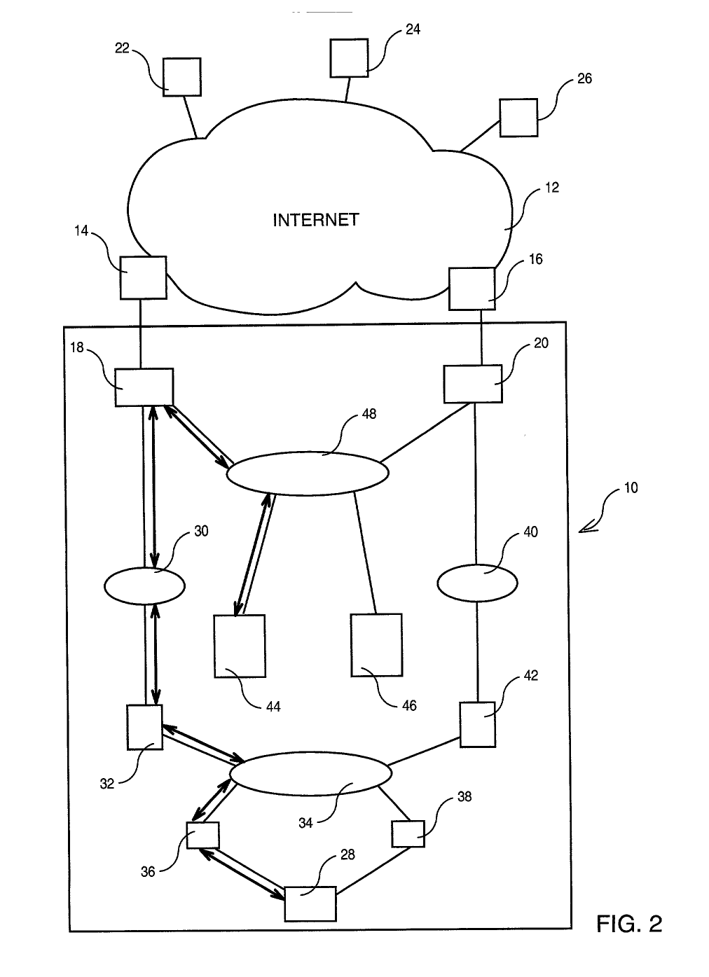

The second step includes monitoring the availability of the second half path and the customer WEB server 28 from the SLA server and measuring the response time as illustrated by the arrows in FIG. 2.

First, the active SLA server 44 sends a monitoring frame such as a ping to the customer WEB server. A default route is configured in both SLA servers to reach this address with a next hop being the virtual IP address of Internet Access routers 18 or 20 (via the fourth switching group 48). The two Internet Access routers may be configured in a mode that allows one to be active and the other to be in standby mode. In this case, the active router, for example router 18, responds to all the frames sent to the virtual IP address defined for the pair of routers. The goal is to use the same router as the one used by the end users when connecting to the farm.

The active Internet Access router 18 forwards the received frames to the active bandwidth controller 32 (via the first switching group 30). Note that the bandwidth controllers may be configured in a mode that allows one of them, here bandwidth controller 32, to be active, and the other one 42 to be in standby mode. In this case, active bandwidth controller 32 responds to all the frames sent to the virtual IP address defined for the pair of controllers. The goal is to use the same bandwidth controller as the one used by the end users when connecting to the farm.

Then, the active bandwidth controller 32 forwards the frame to the active firewall 36 (via the second switching group 34). Note that the pair of firewalls 36 and 38 may also be configured in a mode that allows one of them to be active, here firewall 36, and the other one 38 to be in standby mode. In this case, the active firewall responds to all the frames sent to the virtual address defined for the pair of firewalls. The goal is to use the same firewall as the one used by the end user when connecting to the farm.

The customer WEB server 28 receives the monitoring frame and responds to the active firewall 36, which in turn forwards the responding message to the active bandwidth controller 32. The latter sends the response to the active Internet Access router 18 which in turn forwards the frame back to the active SLA server 44, which has initiated the monitoring.

As mentioned previously, the monitoring of the customer WEB server may be based upon a periodic “ping” mechanism that verifies that the second half path and the server are up and running from a hardware and basic operating system point of view. This monitoring may include periodic access to the home page of the WEB server (URL monitoring) in order to check whether the application running in the WEB server is also up and running.

Together with periodically monitoring that the second half path is up and running, response times are also gathered. The active SLA server may thus correlate the results from the monitoring and the response times of the two half paths and provide global statistics showing the availability and response time between the ISP routers and the customer WEB server. Note that the transmission time between Internet Access router 18 (or Internet Access router 20) and the active SLA router, and reciprocally, must be subtracted from the response time measured by each pair of ping and response messages.

In case of failure on any link of the Internet Access Routers or the bandwidth Controllers or the Firewalls, an automatic backup may be performed from the active device to the backup device. As the monitoring flows use the virtual addresses all along the paths, these monitoring flows will automatically be backed up on the new active devices, just as the real connections coming from end users in the Internet, the objective being to always use the same path as end users connection for the monitoring flows.

We claim:

1. Server farm apparatus, comprising:
a web server in a server farm; and
a service level agreement server;
wherein the web server is connected to an Internet Protocol network outside the server farm by a communication path that includes a first half path and a second half path, and wherein the service level agreement server includes means for monitoring availability of the first half path and means for monitoring availability of the second half path.

2. Server farm apparatus, comprising:
a web server in a server farm; and
a service level agreement server;
wherein the web server is connected to an Internet Protocol network outside the server farm by a communication path that includes a first half path and a second half path, and wherein the service level agreement server includes means for monitoring response time of the first half path and means for monitoring response time of the second half path.

3. A server farm, comprising:
an Internet access router within the server farm, connected to an Internet Service Provider router outside the server farm by a first half path;
a web server within the server farm, connected to the Internet access router by a second half path; and
a service level agreement server connected through the Internet access router to the Internet Service Provider router by a path that includes the first half path, and connected through the Internet access router to the web server by a path that includes the second half path.

4. The server farm of claim 3, wherein the service level agreement server includes means for monitoring availability of the first half path.

5. The server farm of claim 3, wherein the service level agreement server includes means for monitoring response time of the first half path.

6. The server farm of claim 3, wherein the service level agreement server sends a ping message to the Internet Service Provider router over the path that includes the first half path and receives a response message from the Internet Service Provider router returned over the path that includes the first half path.

7. The server farm of claim 3, wherein the service level agreement server includes means for monitoring availability of the second half path.

8. The server farm of claim 3, wherein the service level agreement server includes means for monitoring response time of the second half path.

9. The server farm of claim 3, wherein the service level agreement server sends a ping message to the web server over the path that includes the second half path, and receives a response message from the web server returned over the path that includes the second half path.

10. The server farm of claim 3, wherein the service level agreement server sends a first ping message to the Internet Service Provider router over the path that includes the first half path and receives a first response message from the Internet Service Provider router returned over the path that includes the first half path, sends a second ping message to the web server over the path that includes the second half path and receives a second response message from the web server returned over the path that includes the second half path, and, responsive to receiving the first response message and the second response message, determines availability and response time of the server farm.

11. A server farm, comprising:
an Internet access router within the server farm, connected to an Internet Service Provider router outside the server farm by a first half path;
a web server within the server farm, connected to the Internet access router by a second half path; and
a service level agreement server connected through the Internet access router to the Internet Service Provider router by a path that includes the first half path, and connected through the access router to the web server by a path that includes the second half path, said service level agreement server comprising means for monitoring availability of the first half path, means for monitoring response time of the first half path, means for monitoring availability of the second half path, and means for monitoring response time of the second half path.

12. A server farm, comprising:
an Internet access router within the server farm, connected to an Internet Service Provider router outside the server farm by a first half path;
a web server within the server farm, connected to the Internet access router by a second half path; and
a service level agreement server connected through the Internet access router to the Internet Service Provider router by a path that includes the first half path, and connected through the Internet access router to the web server by a path that includes the second half path, wherein said service level agreement server sends a first ping message to the Internet access router over the path that includes the first half path and receives a first response message returned by the Internet access router over the path that includes the first half path, and wherein said service level agreement server sends a second ping message to the web server over the path that includes the second half path and receives a second response message returned by the web server over the path that includes the second half path.
